(19) United States
(12) Patent Application Publication
(10) Pub. No.: US 2011/0036326 A1
(43) Pub. Date: Feb. 17, 2011

(54) THROTTLE ASSEMBLY

(75) Inventor: Shaun Addy, Lincolnshire (GB)

Correspondence Address: REISING ETHINGTON P.C., P O BOX 4390, TROY, MI, 48099-4390, US

(73) Assignee: IP CONSORTIUM LIMITED, Poole, Dorset (GB)

(21) Appl. No.: 12/988,944

(22) PCT Filed: Apr. 21, 2009
(86) PCT No.: PCT/GB09/50403

§ 371 Date: Oct. 21, 2010

(30) Foreign Application Priority Data
Apr. 21, 2008 (GB) 0807228.2

(51) Int. Cl. F02D 9/08

(52) U.S. Cl. 123/337

(57) ABSTRACT

A throttle assembly comprising: a body portion defining a gas flow channel, the body portion being arranged to allow a flow of gas to be established through the gas flow channel from a gas inlet to a gas outlet of the assembly; and an injector arranged to inject fuel into the gas flow channel, wherein the injector is arranged such that a centreline of a flow of fuel from the injector is substantially parallel to a centreline of a portion of the channel into which fuel is injected thereby to reduce an amount of fuel impinging on a sidewall of the channel.

### FIELD OF THE INVENTION

The present invention relates to a throttle assembly. In particular but not exclusively the invention relates to a throttle assembly for an internal combustion engine having a throttle body and a fuel injector.

### BACKGROUND

A throttle body in combination with a fuel injector is generally used to provide a mixture of air and fuel vapour to an inlet of a combustion chamber of an internal combustion engine.

FIG. 1 shows a typical prior art throttle assembly 100 having a throttle body 110 in combination with a known fuel injector 150. The throttle body has a housing 112 defining a channel 114 through which a gas (typically air) flows from a gas inlet 115 of the throttle body to a gas outlet 116. A throttle valve 120 is used to vary a rate of flow of gas between the inlet 115 and outlet 116. In the throttle body 110 shown in FIG. 1 the throttle valve 120 is a butterfly valve.

The fuel injector 150 has a fluid outlet 152 arranged to inject fuel into the channel 114 of the throttle body 110.

### STATEMENT OF THE INVENTION

In a first aspect of the invention there is provided a throttle assembly comprising: a body portion defining a gas flow channel, the body portion being arranged to allow a flow of gas to be established through the gas flow channel and out from a gas outlet of the assembly; and an injector arranged to inject fuel into the gas flow channel, wherein the injector is arranged such that a centreline of a flow of fuel from the injector is substantially parallel to a centreline of a portion of the channel into which fuel is injected thereby to reduce an amount of fuel impinging on a sidewall of the channel.

Throttle assemblies according to some embodiments of the invention have the feature that an amount of fuel injected into the channel by the injector portion that impinges upon a wall of the channel is reduced relative to known prior art throttle assemblies. This has the advantage that an improved efficiency of operation of an engine to which a throttle assembly according to an embodiment of the invention is mounted may be increased. This is at least in part because the direction of flow of fuel from the fuel injector of the assembly is directed generally parallel to the direction of flow of gas through the channel.

It is to be understood that in some embodiments of the invention the gas is air; other gases may also be useful. For example, nitrous oxide, an air/nitrous oxide mixture, hydrogen or any other suitable gas or mixture of gases.

Some embodiments of the invention have the advantage that a more compact throttle assembly may be constructed. Some embodiments have the advantage that a symmetrical spray pattern and a more uniform distribution of fuel into the flow of air through the air flow channel may be established. This has the advantage that a more uniform distribution of fuel within the gas flow downstream of the injector may be established.

Furthermore, in some embodiments an amount of fuel wash/condensation on a wall of the gas flow channel is reduced. Thus, improved fuel atomisation and acclimatisation during induction and combustion may be obtained.

Alternatively or in addition the injector may be arranged such that the centreline of the flow of fuel from the injector is substantially coincident with a centreline of the portion of the channel into which fuel is injected.

Preferably the injector is arranged such that the centreline of the flow of fuel from the injector is substantially coincident with the centreline of the flow of gas through the portion of the channel into which fuel is injected.

The gas flow channel may comprise at least one conduit upstream of the injector.

The assembly may comprise a flow restrictor member, the restrictor member being arranged to be movable thereby to allow a flow rate of gas through the at least one conduit to be controlled.

Preferably the restrictor member is movable to allow a size of a cross-sectional area of a portion of the channel to be changed thereby to allow the flow rate of gas through the channel to be controlled.

More preferably the restrictor member is movable to allow a size of a cross-sectional area of a portion of the at least one conduit to be changed thereby to allow the flow rate of gas through the channel to be changed.

Preferably the restrictor member is movable with respect to the body portion thereby to increase or decrease an amount of the restrictor member that blocks a flow of gas through the at least one conduit thereby to allow a flow rate of gas through the at least one conduit to be controlled.

The flow restrictor member may be rotatable with respect to the body portion.

The restrictor member may be rotatable about an axis substantially coincident with a longitudinal axis of the injector.

Alternatively or in addition the restrictor member may be slidable with respect to the body portion.

The restrictor member may be slidable parallel to a longitudinal axis of the assembly.

The restrictor member may be provided with an aperture therethrough, the restrictor member being provided in a flowpath of gas through the at least one conduit, the restrictor member being movable thereby to allow an amount of the aperture of the restrictor member that is presented to gas flowing through the at least one conduit to be varied thereby to vary a flow rate of gas through the at least one conduit.

A plurality of conduits may be provided.

This has the advantage that a flow pattern of gas past the injector portion and downstream from the injector portion may be arranged to be substantially symmetrical. Other arrangements are also useful.

The plurality of conduits may comprise at least one pair of conduits provided at diametrically opposed positions with respect to the injector.

The assembly may be arranged to promote swirl of gas flowing through the gas flow channel.

This feature has the advantage that further improved mixing of fuel and gas may be established.

The at least one conduit may be shaped to promote swirl of gas through the gas flow channel.

Preferably the at least one conduit is twisted thereby to promote swirl.

In a second aspect of the invention there is provided an internal combustion engine comprising a throttle assembly as claimed in any preceding claim.

The engine may be a rotary engine, optionally a Wankel rotary engine.

In a third aspect of the invention there is provided a method of generating a fuel/gas mixture comprising providing a throttle assembly comprising: a body portion defining a gas flow channel, the body portion being arranged to allow a flow of gas to be established through the gas flow channel from a gas inlet to a gas outlet of the assembly; and an injector arranged to inject fuel into the gas flow channel, wherein the injector is arranged such that a centreline of a flow of fuel from the injector is substantially parallel to a centreline of a portion of the channel into which fuel is injected thereby to reduce an amount of fuel impinging on a sidewall of the channel.

The method may further comprise the step of passing a gas through the gas flow channel and simultaneously injecting fuel into the channel by means of the injector thereby to generate said fuel/gas mixture.

The method may further comprise the step of igniting the fuel/gas mixture.

The gas may be air.

In one aspect of the invention there is provided a throttle assembly comprising: a housing defining a gas flow channel through which gas may flow from a gas inlet to a gas outlet of the throttle body, the channel being arranged to direct gas to flow through the housing in a direction generally parallel to a longitudinal axis of the channel; and a fuel injector portion having an injector outlet arranged to inject fuel into the channel in a direction substantially parallel to the direction of flow of gas through the channel.

Reference to an injector outlet arranged to inject fuel into the channel in a direction substantially parallel to the direction of flow of gas through the channel is intended to include injection in a direction substantially parallel to a flow of gas in a portion of the channel downstream of the injector outlet. This is because in some embodiments a flow of gas through the channel may be arranged to converge downstream of the injector once the gas has passed the injector.

Reference to the injector portion being arranged to inject fuel into the channel in a direction substantially parallel to a direction of flow of gas through the channel is intended to include not only orientations of the fuel injector that result in fuel injection into the channel in a direction substantially parallel to a longitudinal axis of the channel but also orientations of the fuel injector that result in fuel injection into the channel in a direction that is at a non-zero angle to the longitudinal axis of the channel but which in use does not result in a substantial amount of fuel impinging onto a sidewall of the channel.

The fluid outlet of the injector portion may be arranged to be substantially coaxial with the channel of the housing.

### BRIEF DESCRIPTION OF THE DRAWINGS

Embodiments of the invention will now be described with reference to the accompanying figures in which:

FIG. 1 shows a cross-sectional view of a prior art throttle body;

FIG. 2 shows a cross-sectional view of a throttle body according to an embodiment of the invention;

FIG. 3 shows a perspective cut-away view of a throttle body according to the embodiment of FIG. 2; and

FIG. 4 shows a further perspective cut-away view of a throttle body according to the embodiment of FIG. 2.

### DETAILED DESCRIPTION

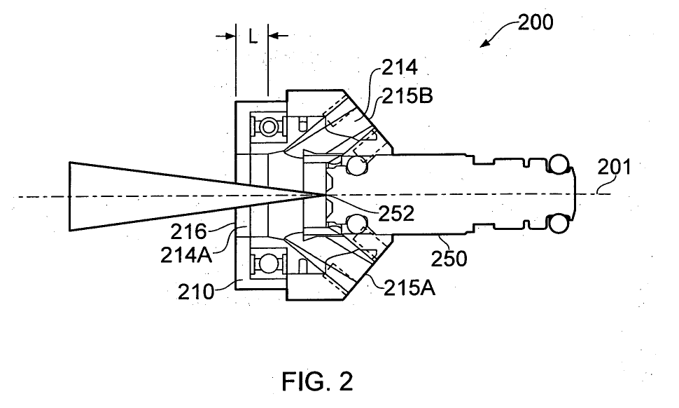

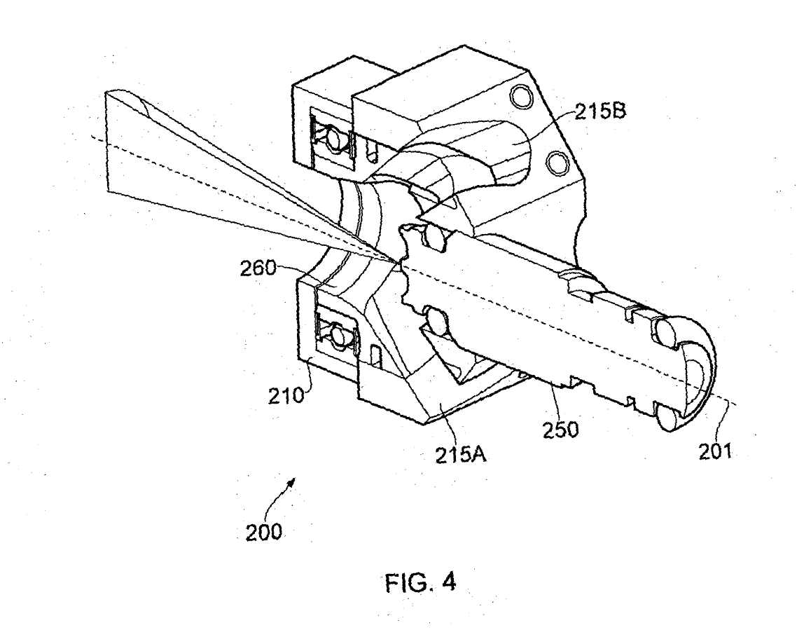

FIGS. 2 and 4 show a throttle assembly 200 according to an embodiment of the invention having a throttle body portion 210 and an injector portion 250. The assembly 200 is provided with a pair of gas inlet conduits 215A, 215B arranged generally symmetrically about a longitudinal axis 201 of the assembly 200. The gas inlet conduits 215A, 215B form part of a gas flow channel 214 and are arranged to supply a flow of gas (typically air) to a portion 214A of a channel 214 of the assembly 200 that is downstream of the injector portion 250.

It is to be understood that in some embodiments more than two inlet conduits are provided. In some embodiments more than two pairs of inlet conduits are provided.

In the embodiment of FIGS. 2 and 4 the inlet conduits 215A, 215B are provided at diametrically opposed positions with respect to the longitudinal axis 201 of the assembly 200 about the injector portion 250. Other arrangements of the gas inlet conduits 215A, 215B are also useful. In some embodiments one gas inlet conduit is provided. In some embodiments more than two gas inlet conduits are provided.

The injector portion 250 is mounted substantially coaxially of the channel portion 214 and is arranged to inject a supply of fuel into the channel portion 214 along a longitudinal axis 201 of the channel portion 214. In the embodiment of FIG. 2 the longitudinal axis 201 of the channel portion 214 corresponds to a longitudinal axis 201 of the throttle assembly 200.

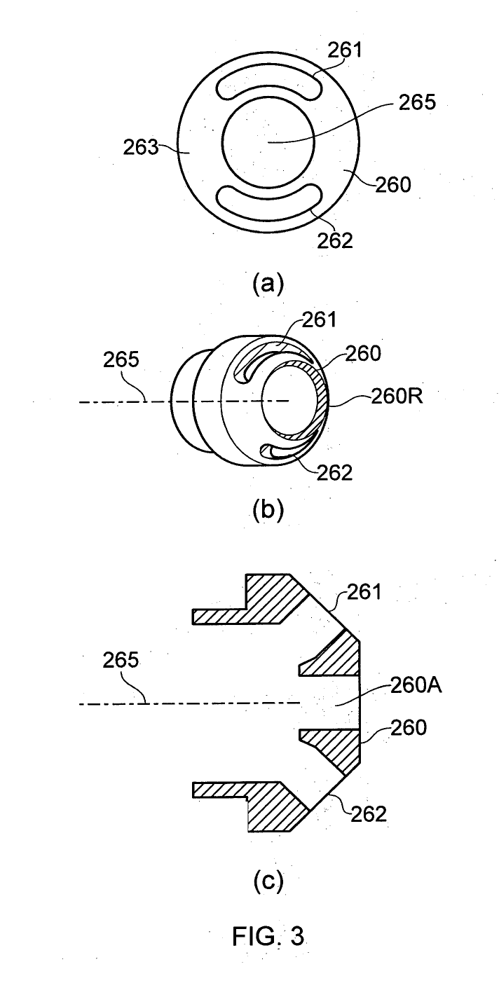

In the embodiments of FIGS. 2 and 4 a restrictor member 260 (FIG. 3) is provided within the throttle body 210. The restrictor member 260 is operable to restrict a flow of gas into the downstream portion 214A of the channel portion 214 from the inlet conduits 215A, 215B.

In the embodiment shown, the restrictor member 260 has a portion that is substantially frusto-conical in shape. A pair of apertures 261, 262 are provided through the frusto-conical portion at diametrically opposed locations. In the embodiment shown the apertures 261, 262 are substantially arcuate and arranged about a longitudinal axis of the restrictor member 260. The longitudinal axis of the restrictor member 260 is arranged to be coincident with that of the assembly 200 with the restrictor member 260 installed in the assembly 200.

The symmetrical arrangement of the inlet conduits 215A, 215B and apertures 261, 262 of the restrictor member 260 allows a substantially symmetrical flow of air to be established through the assembly 200.

The restrictor member 260 is provided with an aperture 260A therethrough arranged to allow a tip portion of the injector portion 250 to be inserted therethrough such that a longitudinal axis of the injector portion 250 is substantially coincident with a longitudinal axis of the restrictor member 260.

In the embodiment shown an opening of the aperture 260A is defined by a rim portion 260R of the restrictor member, the rim portion 260R being oriented normal to a longitudinal axis 265 of the restrictor member 260.

A longitudinal axis of the restrictor member 260 is provided coaxial with the longitudinal axis 201 of the assembly 200 (and therefore the injector portion 250 as described above).

The restrictor member 260 is configured such that by rotation of the member 260 about its longitudinal axis, apertures 261, 262 may be brought into alignment with the gas inlet conduits 215A, 215B thereby to provide a fluid flow path through the restrictor member from the inlet conduits 215A, 215B to the channel portion 214.

It is to be understood that a cross-sectional area of a fluid flow path through the channel 214 may be varied in size by rotation of the restrictor member 260 thereby to change an area of overlap of apertures 261, 262 with conduits 215A, 215B.

In some embodiments a restrictor member having one or more apertures therethrough is provided that is slidable with respect to a portion of the assembly thereby to change an area of overlap of the one of more apertures of the restrictor member with a corresponding one or more conduits of the assembly. In some embodiments the restrictor member is moved by a combined sliding/rotational action.

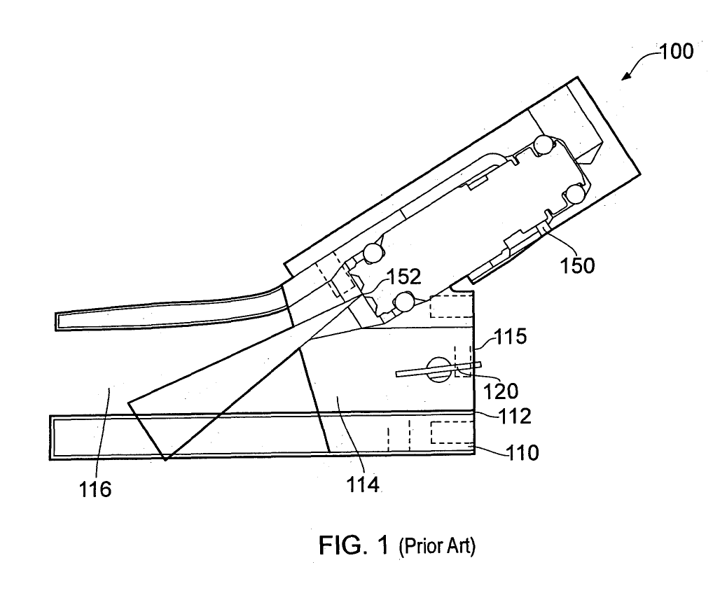

Some embodiments of the invention have the advantage that an efficiency of operation of an engine to which the assembly 200 is coupled is increased. This is at least in part because an amount of fuel injected into the downstream portion 214A of the channel that impinges on a wall of the channel 214 may be reduced relative to prior art arrangements such as that shown in FIG. 1. This is because fuel is injected in a direction substantially parallel to the direction of flow of gas through the channel portion 214 downstream of the injector portion 250.

In the embodiment of FIGS. 2 to 4 a centreline of a jet of fuel produced by the injector portion 250 is substantially coincident with a longitudinal axis 201 of the assembly 200. This feature further enhances an efficiency of operation of the assembly 200. This is because in some embodiments this allows a reduction in an amount of fuel impinging on a wall of the injector assembly 200 relative to embodiments in which fuel is not injected along a direction substantially coincident with a longitudinal axis 201 of the assembly 200.

In some embodiments the conduits 215A, 215B are twisted to promote development of swirl of a flow of gas through the conduits 215A, 215B. This has the advantage that mixing of fuel and gas downstream of the injector portion 250 may be enhanced.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A throttle assembly comprising:
a body portion defining a gas flow channel, the body portion being arranged to allow a flow of gas to be established through the gas flow channel from a gas inlet to a gas outlet of the assembly; and
an injector arranged to inject fuel into the gas flow channel;
wherein the injector is arranged such that a centerline of a flow of fuel from the injector is substantially parallel to a centerline of a portion of the channel into which fuel is injected thereby to reduce an amount of fuel impinging on a sidewall of the channel.

2. An assembly as claimed in claim 1 wherein the injector is arranged such that the centerline of the flow of fuel from the injector is substantially coincident with a centerline of:
the portion of the channel into which fuel is injected; and/or
the flow of gas through the portion of the channel into which fuel is injected.

3. (canceled)

4. An assembly as claimed in claim 1 wherein the gas flow channel comprises at least one conduit upstream of the injector.

5. An assembly as claimed in claim 4 comprising a flow restrictor member arranged to be movable thereby to allow a flow rate of gas through the at least one conduit to be controlled.

6. An assembly as claimed in claim 5 wherein the restrictor member is movable to allow a size of a cross-sectional area of a portion of the at least one conduit to be changed thereby to allow the flow rate of gas through the channel to be controlled.

7. An assembly as claimed in claim 6 wherein the restrictor member is movable with respect to the body portion thereby to increase or decrease an amount of the restrictor member that blocks a flow of gas through the at least one conduit thereby to allow a flow rate of gas through the at least one conduit to be controlled.

8. An assembly as claimed in claim 5 wherein the restrictor member is rotatable with respect to the body portion.

9. An assembly as claimed in claim 5 wherein the restrictor member is slidable with respect to the body portion.

10. An assembly as claimed in claim 9 wherein the restrictor member is slidable parallel to a longitudinal axis of the assembly.

11. An assembly as claimed in claim 5 wherein the restrictor member is provided with an aperture therethrough, the restrictor member being provided in a flowpath of gas through the at least one conduit, the restrictor member being movable thereby to allow an amount of the aperture of the restrictor member that is presented to gas flowing through the at least one conduit to be varied thereby to vary a flow rate of gas through the at least one conduit.

12. An assembly as claimed in claim 4 wherein a plurality of conduits are provided.

13. An assembly as claimed in claim 11 wherein a plurality of apertures are provided in the restrictor member, each aperture of the restrictor member being associated with a conduit of the assembly and being arranged to allow gas flowing through said conduit to pass therethrough.

14. An assembly as claimed in claim 13 comprising at least one pair of conduits provided at diametrically opposed positions with respect to the injector.

15. An assembly as claimed in claim 5 wherein the restrictor member is rotatable about an axis substantially coincident with a longitudinal axis of the injector.

16. An assembly as claimed in claim 1 arranged to promote swirl of gas flowing through the gas flow channel.

17. (canceled)

18. An assembly as claimed in claim 4 wherein the at least one conduit is twisted thereby to promote swirl of as through the as flow channel.

19. An internal combustion engine comprising a throttle assembly as claimed claim 1.

20. An internal combustion engine as claimed in claim 19 wherein the engine is a a Wankel or other rotary engine.

21. A method of generating a fuel/gas mixture comprising:
passing a as through a gas flow channel from a gas inlet to a gas outlet of a throttle assembly; and
injecting fuel into the gas flow channel, such that a centerline of a flow of injected fuel is substantially parallel to a centerline of a portion of the channel into which fuel is injected thereby to reduce an amount of fuel impinging on a sidewall of the channel.

22. A method as claimed in claim 21 comprising rotating a flow restrictor relative to the gas flow channel thereby to control a flow rate of gas through the gas flow channel.

23-27. (canceled)

28. A method as claimed in claim 21 comprising diverting the gas through an angle of less than 90° from the gas inlet to the gas outlet.

29. A method as claimed in claim 21 comprising promoting swirl of gas through the gas flow channel.

30. A throttle assembly comprising:
a body portion defining a gas flow channel, the body portion being arranged to allow a flow of gas to be established through the gas flow channel from a gas inlet to a gas outlet of the assembly;
an injector arranged to inject fuel into the gas flow channel, the injector being arranged such that a centerline of a flow of fuel from the injector is substantially parallel to a centerline of a portion of the channel into which fuel is injected thereby to reduce an amount of fuel impinging on a sidewall of the channel; and
a flow restrictor member having a frusto-conical portion for cooperation with the body portion and arranged to be rotatable relative thereto thereby to allow a flow rate of gas through the gas flow channel to be controlled.
